(19) United States
(12) Patent Application Publication
(10) Pub. No.: US 2025/0039602 A1
(43) Pub. Date: Jan. 30, 2025

(54) Apparatus, Methods and Computer Programs for Providing Spatial Audio

(71) Applicant: Nokia Technologies Oy, Espoo (FI)

(72) Inventors: Juha Tapio Vilkamo, Helsinki (FI); Mikko-Ville LAITINEN, Espoo (FI)

(21) Appl. No.: 18/716,986

(22) PCT Filed: Nov. 25, 2022
(86) PCT No.: PCT/FI2022/050788

§ 371 Date: Jun. 6, 2024

(30) Foreign Application Priority Data
Dec. 22, 2021 (GB) 2118738.0

(51) Int. Cl. H04R 3/00

(52) U.S. Cl. CPC H04R 3/005; H04S 2400/15; H04S 2420/11

(57) ABSTRACT

Examples of the disclosure relate to apparatus, methods and computer programs for providing spatial audio. In examples of the disclosure speech or other sources of a first category can be identified. Spatial information relating to the speech or sources of a first category can be determined using data obtained from audio signals. The identified speech or other sources of a first category can then be spatially reproduced using the spatial information. This can enable the speech or other sources of a first category to be enhanced compared to other parts of the sound signals. This can provide for improved spatial audio content.

### TECHNOLOGICAL FIELD

Examples of the disclosure relate to apparatus, methods and computer programs for providing spatial audio. Some relate to apparatus, methods and computer programs for providing spatial audio with improved quality.

### BACKGROUND

Spatial audio enables spatial properties of a sound scene to be reproduced for a user so that the user can perceive the spatial properties. This can provide an immersive audio experience for a user or could be used for other applications.

### BRIEF SUMMARY

According to various, but not necessarily all, examples of the disclosure there is provided an apparatus comprising means for:
obtaining input data for a trained machine learning model wherein the input data is based on audio signals from two or more microphones configured for spatial audio capture;
determining, using the input data and the trained machine learning model, spatial information relating to one or more sources of at least a first category captured within the audio signals;
separating, at least partially, a portion of the audio signals corresponding to the one or more sources of at least the first category from a remainder of the audio signals; and
processing the portion corresponding to the one or more sources of at least the first category based on the spatial information determined using the trained machine learning model and processing at least the remainder of the audio signals based on information in the two or more audio signals.

The processing of the one or more sources of at least the first category may increase the relative volume of the one or more sources of at least the first category compared to the remainder.

The trained machine learning model may be used to separate, at least partially, a portion of the audio signals corresponding to the one or more sources of at least the first category from a remainder of the audio signals.

A different machine learning model may be used to separate, at least partially, a portion of the audio signals corresponding to the one or more sources of at least the first category from a remainder of the audio signals.

The one or more sources of at least the first category may comprise speech.

The remainder of the audio signals may comprise ambient noise.

The trained machine learning model may be configured to provide one or more masks that enables a portion corresponding to the one or more sources of at least the first category to be obtained.

The spatial information relating to one or more sources of at least the first category may be estimated from a covariance matrix.

The spatial information relating to one or more sources of at least the first category may comprise a steering vector.

The spatial information may be used to obtain the portion corresponding to the one or more sources of at least the first category.

The spatial information may be used to direct a beamformer towards the one or more sources of at least the first category.

A filter may be applied to the beamformed signal to emphasize the portion based upon the one or more sources of at least the first category of the signal and suppress the remainder.

According to various, but not necessarily all, examples of the disclosure there is provided an electronic device comprising an apparatus as described herein wherein the electronic device is at least one of: a telephone, a camera, a computing device, a teleconferencing apparatus. According to various, but not necessarily all, examples of the disclosure there is provided a method comprising:
obtaining input data for a trained machine learning model wherein the input data is based on audio signals from two or more microphones configured for spatial audio capture;
determining, using the input data and the trained machine learning model, spatial information relating to one or more sources of at least a first category captured within the audio signals;
separating, at least partially, a portion of the audio signals corresponding to the one or more sources of at least the first category from a remainder of the audio signals; and
processing the portion corresponding to the one or more sources of at least the first category based on the spatial information determined using the trained machine learning model and processing at least the remainder of the audio signals based on information in the two or more audio signals.

According to various, but not necessarily all, examples of the disclosure there is provided a computer program comprising computer program instructions that, when executed by processing circuitry, cause:
obtaining input data for a trained machine learning model wherein the input data is based on audio signals from two or more microphones configured for spatial audio capture;
determining, using the input data and the trained machine learning model, spatial information relating to one or more sources of at least a first category captured within the audio signals;
separating, at least partially, a portion of the audio signals corresponding to the one or more sources of at least the first category from a remainder of the audio signals; and
processing the portion corresponding to the one or more sources of at least the first category based on the spatial information determined using the trained machine learning model and processing at least the remainder of the audio signals based on information in the two or more audio signals.

### BRIEF DESCRIPTION

Some examples will now be described with reference to the accompanying drawings in which:

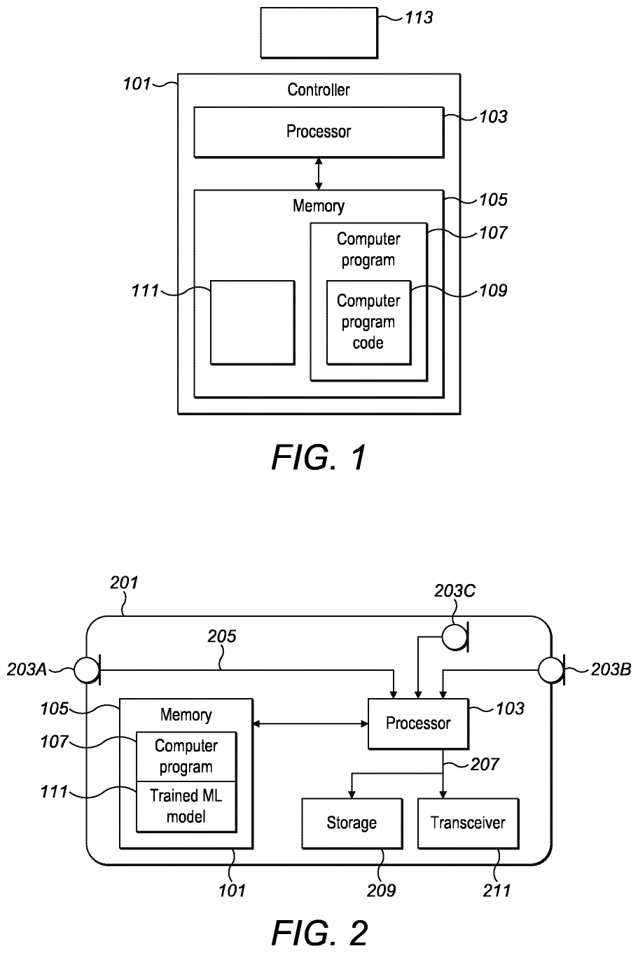

FIG. 1 shows an example apparatus;

FIG. 2 shows an example electronic device comprising an apparatus;

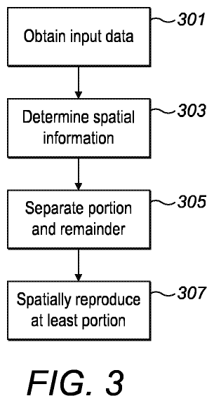

FIG. 3 shows an example method;

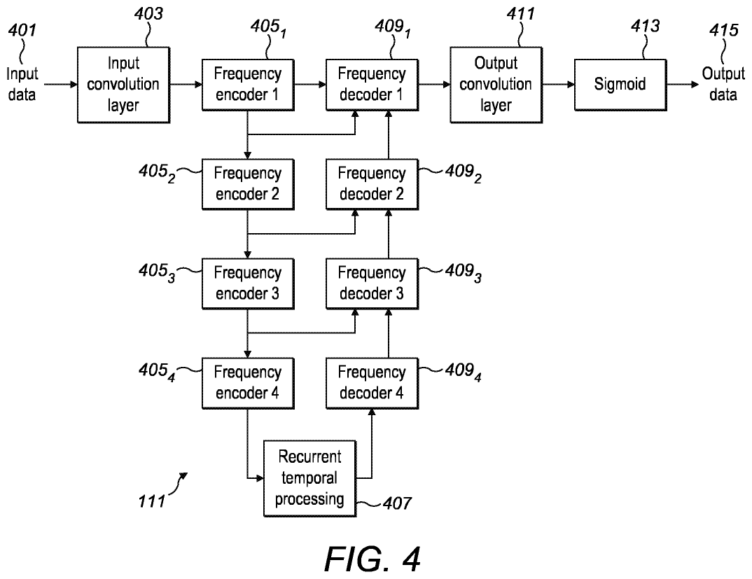

FIG. 4 shows an example structure for a machine learning model;

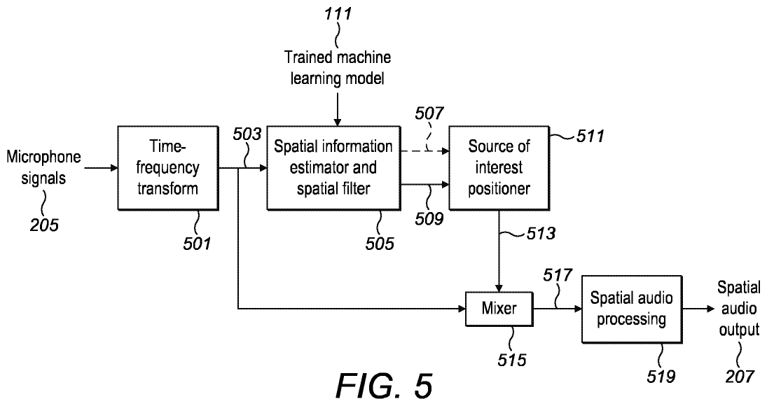

FIG. 5 shows an example method;

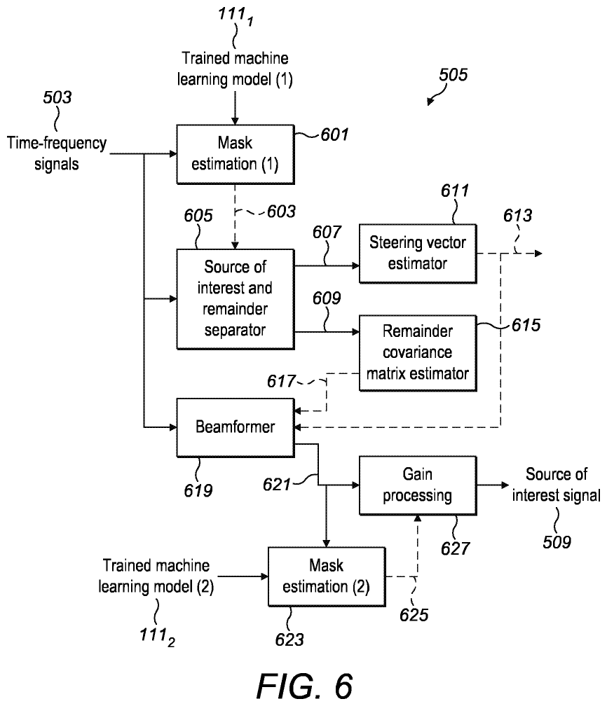

FIG. 6 shows an example method;

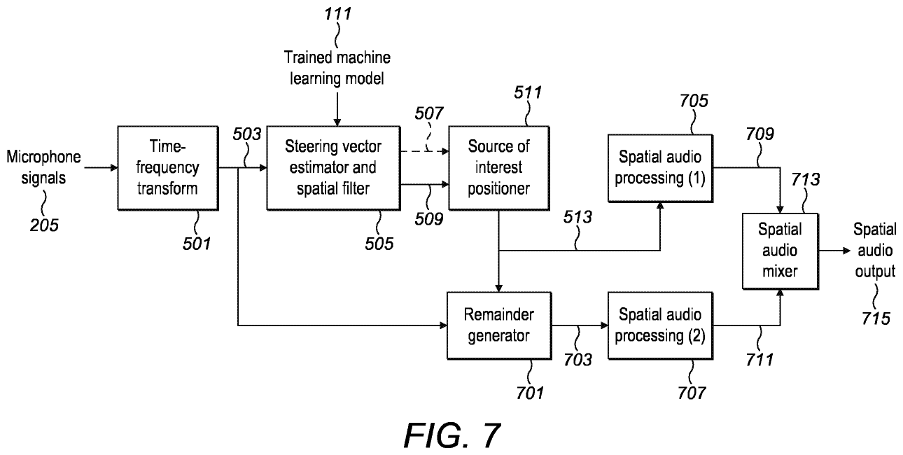

FIG. 7 shows an example method;

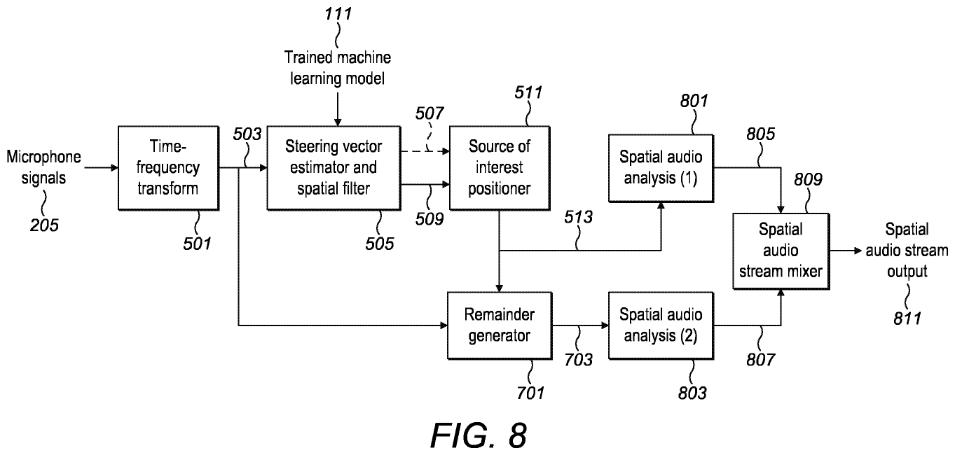

FIG. 8 shows an example method; and

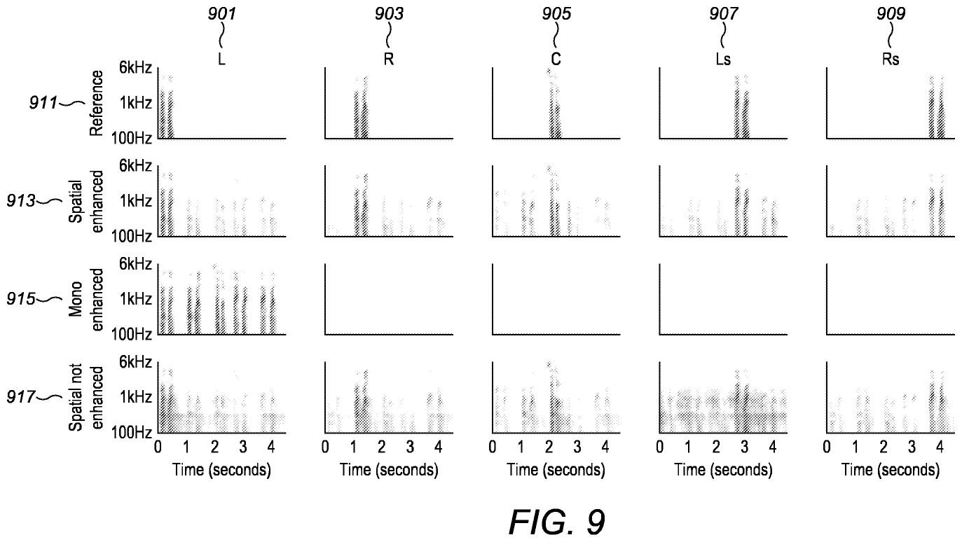

FIG. 9 shows example results.

### DETAILED DESCRIPTION

Examples of the disclosure relate to apparatus, methods and computer programs for providing spatial audio. In examples of the disclosure speech or other sources of a first category can be identified. Spatial information relating to the speech or sources of a first category can be determined using data obtained from audio signals. The identified speech or other sources of a first category can then be spatially reproduced using the spatial information. This can enable the speech or other sources of a first category to be enhanced compared to other parts of the sound signals. This can provide for improved spatial audio content.

FIG. 1 schematically shows an example apparatus 101 that could be used in some examples of the disclosure. In the example of FIG. 1 the apparatus 101 comprises at least one processor 103 and at least one memory 105. It is to be appreciated that the apparatus 101 could comprise additional components that are not shown in FIG. 1.

The apparatus 101 can be configured to use a machine learning model, or other suitable methods or algorithms, to enable spatial sound to be reproduced from two or more audio signals. The audio signals can be from two or more microphones configured for spatial audio capture.

In the example of FIG. 1 the implementation of the apparatus 101 can be implemented as processing circuitry. In some examples the apparatus 101 can be implemented in hardware alone, have certain aspects in software including firmware alone or can be a combination of hardware and software (including firmware).

As illustrated in FIG. 1 the apparatus 101 can be implemented using instructions that enable hardware functionality, for example, by using executable instructions of a computer program 107 in a general-purpose or special-purpose processor 103 that can be stored on a computer readable storage medium (disk, memory etc.) to be executed by such a processor 103.

The processor 103 is configured to read from and write to the memory 105. The processor 103 can also comprise an output interface via which data and/or commands are output by the processor 103 and an input interface via which data and/or commands are input to the processor 103.

The memory 105 is configured to store a computer program 107 comprising computer program instructions (computer program code 109) that controls the operation of the apparatus 101 when loaded into the processor 103. The computer program instructions, of the computer program 107, provide the logic and routines that enables the apparatus 101 to perform the methods illustrated in FIGS. 3 to 8. The processor 103 by reading the memory 105 is able to load and execute the computer program 107.

The memory 105 is also configured to store a trained machine learning model 111. The trained machine learning model 111 can be configured to identify different portions audio signals. The different portions can be based on different types of sound sources. For instance a first portion can be based on one or more sources of a first category. The sources of a first category could be speech or any other suitable sound sources. A second portion could be based on sound other than the sources of a first category. The second portion could be a remainder. For instance, the second portion could be based on ambient sounds. The trained machine learning model 111 could also be trained to perform any other suitable tasks.

The trained machine learning model 111 can comprise a neural network or any other suitable type of trainable model. The term “Machine Learning Model” refers to any kind of artificial intelligence (AI), intelligent or other method that is trainable or tuneable using data. The machine learning model 111 can comprise a computer program. The machine learning model 111 can be trained to perform a task, such as determining spatial information and obtaining a portion of audio signals that comprise sources of a first category, without being explicitly programmed to perform that task. The machine learning model 111 can be configured to learn from experience E with respect to some class of tasks T and performance measure P if its performance at tasks in T, as measured by P, improves with experience E. in these examples the machine learning model can often learn from reference data to make estimations on future data. The machine learning model 111 can be also a trainable computer program. Other types of machine learning models 111 could be used in other examples.

It is also possible to train one machine learning model 111 with specific architecture, then derive another machine learning model from that using processes such as compilation, pruning, quantization or distillation. The term “Machine Learning Model” covers all these use cases and the outputs of them. The machine learning model 111 can be executed using any suitable apparatus, for example CPU, GPU, ASIC, FPGA, compute-in-memory, analog, or digital, or optical apparatus. It is also possible to execute the machine learning model 111 in apparatus that combine features from any number of these, for instance digital-optical or analog-digital hybrids. In some examples the weights and required computations in these systems can be programmed to correspond to the machine learning model 111. In some examples the apparatus 101 can be designed and manufactured so as to perform the task defined by the machine learning model 111 so that the apparatus 101 is configured to perform the task when it is manufactured without the apparatus 101 being programmable as such.

In the example of FIG. 1 only one machine learning model 111 is shown in the apparatus 101. In other examples the apparatus 101 can be configured so that more than one trained machine learning model 111 is stored in the memory 105 of the apparatus 111 and/or is otherwise accessible by the apparatus 101. In such cases a first machine learning model 111 could be used to determine the spatial information and a second, different machine learning model 111 could be used to obtain the portion based upon the one or more sources of a first category.

The trained machine learning model 111 could be trained by a system that is separate to the apparatus 101. For example, the trained machine learning model 111 could be trained by a system or other apparatus that has a higher processing capacity than the apparatus 101 of FIG. 1. In some examples the machine learning model 111 could be trained by a system comprising one or more graphical processing units (GPUs) or any other suitable type of processor.

The trained machine learning model 111 could be provided to the memory 105 of the apparatus 101 via any suitable means. In some examples the trained machine learning model 111 could be installed in the apparatus 101 during manufacture of the apparatus 101. In some examples the trained machine learning model 111 could be installed in the apparatus 101 after the apparatus 101 has been manufactured. In such examples the machine learning model 111 could be transmitted to the apparatus 101 via any suitable communication network.

The apparatus 101 therefore comprises: at least one processor 103; and at least one memory 105 including computer program code 109, the at least one memory 105 and the computer program code 109 configured to, with the at least one processor 103, cause the apparatus 101 at least to perform:
obtaining input data for a trained machine learning model wherein the input data is based on audio signals from two or more microphones configured for spatial audio capture;
determining, using the input data and the trained machine learning model, spatial information relating to one or more sources of at least a first category captured within the audio signals;
separating, at least partially, a portion of the audio signals corresponding to the one or more sources of at least the first category from a remainder of the audio signals; and
processing the portion corresponding to the one or more sources of at least the first category based on the spatial information determined using the trained machine learning model and processing at least the remainder of the audio signals based on information in the two or more audio signals.

As illustrated in FIG. 1 the computer program 107 can arrive at the apparatus 101 via any suitable delivery mechanism 113. The delivery mechanism 113 can be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 107. The delivery mechanism can be a signal configured to reliably transfer the computer program 107. The apparatus 101 can propagate or transmit the computer program 107 as a computer data signal. In some examples the computer program 107 can be transmitted to the apparatus 101 using a wireless protocol such as Bluetooth, Bluetooth Low Energy, Bluetooth Smart, 6LoWPan (IPV6 over low power personal area networks) ZigBee, ANT+, near field communication (NFC), Radio frequency identification, wireless local area network (wireless LAN) or any other suitable protocol.

The computer program 107 comprises computer program instructions for causing an apparatus 107 to perform at least the following:
obtaining input data for a trained machine learning model wherein the input data is based on audio signals from two or more microphones configured for spatial audio capture;
determining, using the input data and the trained machine learning model, spatial information relating to one or more sources of at least a first category captured within the audio signals;
separating, at least partially, a portion of the audio signals corresponding to the one or more sources of at least the first category from a remainder of the audio signals; and
processing the portion corresponding to the one or more sources of at least the first category based on the spatial information determined using the trained machine learning model and processing at least the remainder of the audio signals based on information in the two or more audio signals.

The computer program instructions can be comprised in a computer program 107, a non-transitory computer readable medium, a computer program product, a machine readable medium. In some but not necessarily all examples, the computer program instructions can be distributed over more than one computer program 107.

Although the memory 105 is illustrated as a single component/circuitry it can be implemented as one or more separate components/circuitry some or all of which can be integrated/removable and/or can provide permanent/semi-permanent/dynamic/cached storage.

Although the processor 103 is illustrated as a single component/circuitry it can be implemented as one or more separate components/circuitry some or all of which can be integrated/removable. The processor 103 can be a single core or multi-core processor.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” can refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software might not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the FIGS. 3 to 8 can represent steps in a method and/or sections of code in the computer program 107. The illustration of a particular order to the blocks does not necessarily imply that there is a required or preferred order for the blocks and the order and arrangement of the block can be varied. Furthermore, it can be possible for some blocks to be omitted.

FIG. 2 shows an example electronic device 201 comprising an apparatus 101. The apparatus 101 can comprise a memory 105 and a processor 103 as shown in FIG. 1. Corresponding reference numerals are used for corresponding features. The electronic device 201 also comprises a plurality of microphones 203, storage 209 and a transceiver 211. Only components of the electronic device 201 that are referred to below are shown in FIG. 2. The electronic device 201 can comprise additional components that are not shown.

The electronic device 201 can comprise any device comprising a plurality of microphones 203. For example, the electronic device 201 could comprise a telephone, a camera a computing device, a teleconferencing apparatus or any other suitable type of electronic device 201.

The microphones 203 can comprise any means that can be configured to detect audio signals. The microphones 203 can be configured to detect acoustic sound signals and convert the acoustic signals into an output electric signal. The microphones 203 therefore provide microphone signals 205 as an output. The microphone signals 205 can comprise audio signals.

The electronic device 201 comprises a plurality of microphones 203. The plurality of microphones 203 comprises two or more microphones 203. The microphones 203 can be arranged in a microphone array which enables spatial audio information to be obtained. The plurality of microphones 203 can be located in different positions within the electronic device 201 so as to enable spatial information to be obtained from the microphone signals 205 or audio signals. In the example of FIG. 2 the electronic device 201 comprises three microphones 203. A first microphone 203A is provided at a first end of the electronic device 201. A second microphone 203B is provided at a second end of the electronic device 201, a third microphone 203C is provided on the rear of the electronic device 201. The third microphone 203C could be located near a camera of the electronic device 201. Other numbers and arrangements of microphones 203 could be used in other examples of the disclosure.

The microphones 203 of the electronic device 201 can be configured to capture the sound environment around the electronic device 201. The sound environment can comprise sounds from sound sources, reverberation, background ambience, and any other type of sounds. The sound environment can comprise one or more sources of a first category. The sources of a first category could comprise speech from one or more people talking or any other suitable types of sound.

The electronic device 201 is configured so that the audio signals 205 from the microphones are provided to the processor 103 as an input. The audio signals 205 can be provided to the processor 103 in any suitable format. In this example the audio signals 205 can be provided to the processor 103 in a digital format. The digital format could comprise pulse code modulation (PCM) or any other suitable type of format. In other examples the microphones 203 could comprise analog microphones 203. In such examples an analog-to-digital converter can be provided between the microphones 203 and the processor 103.

The processor 103 can be configured to process the audio signals 205 to provide a spatial audio output 207. The processor 103 can be configured to use methods as shown in FIGS. 3 to 8 to produce the spatial audio output 207. The processor 103 can be configured to use the trained machine learning model 111 that is stored in the memory 105 to process the audio signals 205 to provide the spatial audio output 207.

In some examples the processor 103 can be configured to determine input data from the audio signals 205 so that the input data can be used an input to the trained machine learning model 111. The processor 103 then uses the trained machine learning model 111 to process the input data to provide the spatial audio output 207 based on the audio signals 205.

The spatial audio output 207 can be provided in any suitable format. For example the spatial audio output 207 can comprise an audio signal and spatial metadata where the spatial metadata enables the spatial sound rendering, an audio signal and spatial metadata where the spatial metadata is provided in an encoded form such as an Immersive Voice and Audio Stream (IVAS), a binaural audio signal, a surround sound loudspeaker signal, Ambisonic audio signals or any other suitable type of spatial audio output 207.

The device 201 shown in FIG. 2 comprises storage 209 and a transceiver 211. The processor 103 is coupled to the storage 209 and/or the transceiver 211 so that the spatial audio output 207, ad/or any other outputs, from the processor 103 can be provided to the storage 209 and/or the transceiver 211.

The storage 209 can comprise any means for storing the spatial audio output 207 and/or any other outputs from the processor 103. The storage 209 could comprise one or more memories or any other suitable means. The spatial audio output 207 can be retrieved from the storage 209 at a later time. This can enable the electronic device 201 to render the spatial audio output 207 at a later time or can enable the spatial audio output 207 to be transmitted to another device.

The transceiver 211 can comprise any means that can enable data to be transmitted from the electronic device 201. This can enable the spatial audio output 207, and/or any other suitable data, to be transmitted from the electronic device 201 to an audio rendering device or any other suitable device.

In some examples the spatial audio output 207 can be associated with other information. For instance, the spatial audio output 207 can be associated with images such as video images. The images or video images could be captured by a camera of the electronic device 201. The spatial audio output 207 can be associated with the other information so that the spatial audio output 207 can be stored with this information and/or can be transmitted with this other information. The association can enable the images or other information to be provided to a user of the rendering device when the spatial audio output 207 is rendered.

In some examples the electronic device 201 can comprise one or more user input devices. The user input device can comprise any means that enables a user to control the electronic device 201. The user input device could comprise touch screens of voice recognition devices or any other suitable means. The user input devices can enable a user of the electronic device 201 to control the capture of spatial audio by the electronic device 201. For example, it can enable a user to control when to start capturing and when to stop capturing the sound environment. The user input device can also be used to control the capture of other information such as images.

FIG. 3 shows an example method that could be performed using an apparatus 101 and/or electronic device 201 as shown in FIGS. 1 and 2.

At block 301 the method comprises obtaining input data for a trained machine learning model 111. The input data is based on two or more audio signals 205 where the audio signals were obtained from two or more microphones 203 configured for spatial audio capture. The input data can be provided in a format that is suitable for use as an input to the trained machine learning model 111. For example, the input data can be provided in a format that can be used by a neural network or any other suitable type of machine learning model 111.

At block 303 the method comprises determining, using the input data, spatial information relating to one or more sources of at least a first category within the audio signals 205. In some examples the trained machine learning model 111 can be used to determine the spatial information. FIGS. 3 to 8 show example methods that can be used to determine spatial information.

The spatial information relating to the sources of a first category can comprise any information that enables spatial rendering of the sound captured from the sources of a first category. The spatial information can comprise information indicative of the direction of arrival of the sources of a first category at the electronic device 201. For example, the spatial information could comprise a steering vector or any other suitable type of information. The steering vector can be obtained using any suitable process. For instance, the steering vector can be estimated in different frequencies by estimating a multi-microphone covariance matrix related to the sources of a first category in those frequencies and performing an eigenvalue decomposition of the covariance matrix to obtain the steering vector from the eigenvectors. Other types of spatial information can be obtained in other examples.

At block 305 the method comprises processing the input data to obtain at least a first portion based upon the one or more sources of a first category. The method can comprise separating a portion of the audio signals corresponding to the one or more sources of a first category from a remainder of the audio signals. The separating can be performed using the trained machine learning model, using a different machine learning model and/or using any other suitable means. The remainder of the audio signals can correspond to sound other than the one or more sources of a first category. The first portion can comprise mainly of sources of a first category. The second portion could comprise a remainder.

The sources of a first category can comprise any suitable sound sources. In some examples the sources of a first category can comprise speech. The speech can come from a single source or from a plurality of sources. Other types of sources of a first category can be used in other examples of the disclosure. For instance, the sources of a first category could comprise an alert, music, bird sounds or any other suitable type of sound. The sources of a first category could comprise sources of interest.

The sound other than the sources of a first category, can be comprised within the remainder. This can comprise any sounds within the audio signals 205 that are not the sources of a first category. The sound other than the sources of a first category can comprise unwanted sounds. The sound other than the sources of a first category can comprise other sounds that make the sources of a first category harder to hear. For instance, the sounds could comprise the ambient noise or other background noises.

A machine learning model 111 can be used to process the input data to enable the first portion to be obtained based upon the one or more sources of a first category and a second portion or remainder. The machine learning model 111 can be trained to recognise particular sounds of a first category and enable these to be identified within the audio signals 205.

In some examples the apparatus 101 can be configured to enable a user to control the sounds that are comprised within the sources of a first category. For example, a user could use a user input device to select one or more types of sources of a first category. In such examples the apparatus 101 could have access to more than one machine learning network 111 so that different machine learning networks 111 can be used to recognise the different types of sound.

In some examples the spatial information obtained at block 303 can be used to obtain the portion based upon the one or more sources of a first category. For example, spatial information such as a steering vector can be used to direct a beamformer towards the sources of a first category. Directing a beamformer means determining beamformer weights that can be applied to the audio signals 205 to obtain the beamformer output where other sounds than those related to the sources of a first category are attenuated. The beamformer can be an adaptive beamformer. This machine learning model 111 (or another machine learning model) can then be used to process the beamform signal (or neural network input data based on beamform signals) so that from the beamform signals the parts of the audio signal that are not from the sources of a first category may be further suppressed.

The separation of the audio signals into the different portions might not be perfect. That is, there might be some leakage or minor errors or any other cause which means that some of the remainder is present in the first portion and some of the audio sources of the first category are present in the second portion. However, these errors and leaks might be small. The error and leaks might be negligible.

At block 307 the method comprises spatially reproducing the portion corresponding to the one or more sources of a first category. Any suitable processing can be used to spatially reproduce the respective portions of the signals. The spatial reproduction of this portion is based on the spatial information determined by the processing.

The remainder, or second portion, can also be spatially reproduced. The spatially reproduction of the second portion or remainder can be based on information in the two or more audio signals 205. That is a first set of information can be used to spatially reproduce the portion based upon the one or more sources of a first category and a second different set of information can be used to spatially reproduce a portion comprising at least the remainder.

In some examples the portion based upon the one or more sources of a first category can be enhanced separately to the remainder and then the enhanced first portion can also be spatially reproduced together with the remainder.

In some examples the spatial reproduction increases the relative volume of the portion based on the sources of a first category compared to the remainder portion. This enhances the portion based on the sources of a first category relative to the remainder portion. This enhancement can provide for improved quality in the spatial audio. This can make the sources of a first category clearer for a listener.

The relative volume of the of the portion based on the sources of a first category compared to the remainder portion can be increased using any suitable process. In some examples the relative volume of the of the sources of a first category portion compared to the remainder portion can be increased by processing the portion based on the sources of a first category using the steering vectors or other spatial information. A weighted combining of the portion based on the sources of a first category and the remainder portion can then be obtained. The weighting within the combination determines the proportions of the portion based on the sources of a first category relative to the remainder portion. A higher weighting for the portion based on the sources of a first category will increase the relative volume of the this portion by a larger amount. The spatial audio analysis for the weighted combination can then be performed using any suitable means.

In some examples the apparatus 101 can be configured to enable a user to control how much the portion based on the sources of a first category is enhanced relative to the remainder portion. For instance, a range of settings could be available and a user could select from this range. The range could cover from providing no enhancement to providing maximal enhancement.

In some examples the same machine learning model 111 can be used to determine the spatial information at block 303 and also to process the input data at block 305 to obtain the portion based on the sources of a first category and the remainder portion.

In some examples a first machine learning model 111 can be used to process the input data to obtain the spatial information at block 303 and a second, different machine learning model 111 can be used to process the audio signals (or input data based on the audio signals) and/or beamform signals (or input data based on beamform signals) at block 305 to obtain the sources of a first category portion and the remainder portion. In some examples it may be beneficial to use different machine learning models 111. This can provide for improved quality in the outputs. For example, the machine learning model 111 that is used to obtain the portion based on the sources of a first category could be trained to use the beamed microphone data instead of the original microphone data. This can enable the identification of the portion based on sources of a first category to be more accurate than a machine learning model that has been trained using the original microphone data.

In the example shown in FIG. 3 the audio signals are separated into a first portion corresponding to sources of a first category and a second portion comprising the remainder. In other examples the audio signals could be separated into more than two portions. For example, a plurality of different categories of sound sources could be determined. The audio signals could then be divided into a plurality of different portions corresponding to the different categories of sound sources and an additional portion corresponding to the remainder.

In the example shown in FIG. 3 the separating of the portion of the signals corresponding to the sources of the first category and the processing of the respective portions have been shown as two distinct blocks. It is to be appreciated that these blocks could be combined and performed in a single process.

FIG. 4 shows an example structure for a machine learning model 111. In this example the machine learning model 111 comprises a neural network. Other types of machine learning model 111 could be used in other examples of the disclosure. The machine learning model 111 comprises an input convolution layer 403, a plurality of frequency encoder blocks 405, a recurrent temporal processing block 407, a plurality of frequency decoder blocks 409, an output convolution layer 411 and a sigmoid block 413.

The machine learning model 111 receives input data 401 as an input. The input data 401 can be obtained from the audio signals 205. The input data 401 can be provided in a format that enables it to be processed by the machine learning model 111.

In this example the input data 401 is provided in the form: num_T×num_F×num_C where num_T is the number of temporal indices and num_F is the number of frequency bands and num_C is the number of input features.

In this example num_F=96, num_C=2, and num_T=64. The time dimension is used the training phase. When the machine learning model 111 is being used after training for inference, for example when it is being used to determine a portion of the audio signals 205 based on sources of a first category, then num_T=1. This enables continuous real-time processing of arbitrary length sequences of input data, one frame at a time.

In this example the number of input features is set at 2. The input data 401 is therefore a concatenation of two feature layers of inputs each of dimensions 64×96. The first feature layer comprises spectrogram data. The spectrogram data comprises the time varying portion of the input data. The second feature layer comprises a time-invariant feature layer. The second feature layer provides frequency-map data that enables the machine learning model 111 to learn to make differing decisions based on the frequency. Other types and numbers of feature layers could be used in other examples. For example, the number of input features could be 10, where first feature is the spectrogram data, and features 2-10 could provide time-invariant frequency embeddings.

The input data 401 therefore comprises a data array having the dimensions 64×96×2. The input data 401 can be denoted as I(n, f, c) where n is the temporal index, f is the frequency band index of the network input and c is the feature index.

The machine learning model 111 can be trained with a time-frequency signal sequence S(n, b, i) where b=1, . . . , N_{bins} is the frequency bin index, and i=1, . . . , N_{ch} is the channel index and n=1, . . . , num_T. Therefore, at the training stage the signal sequences for the input data 401 have a length of num_T temporal indices. During inference the input data signal can be of an arbitrary length. During inference the machine learning model 111 can be called for each temporal index n at the continuous processing. Note that the term “channel” in the field of machine learning may refer to the feature dimension of the data, however, in the foregoing it refers to the channel of the provided audio signals.

The following discusses frequency bins and frequency bands. A frequency bin refers to a single frequency line of the applied time-frequency transform. A frequency band refers to determined combinations of these frequency bins. In a typical configuration, the frequency bins are uniform in frequency resolution, whereas the frequency bands have a non-uniform frequency resolution, typically a logarithmic-like frequency resolution having wider frequency bandwidths at higher frequencies.

During training the first feature of the input data 401 can be obtained by obtaining the energy value in decibels in frequency bands

$${E}_{d B} ( n , f ) = 10 {log}_{10} {\sum }_{b = {b}_{l o w} ( f )}^{{b}_{high} ( f )} {\sum }_{i = 1}^{{N}_{c h}} {\vert S ( n , b i ) \vert}^{2}$$

where b_{low}(f) and b_{high}(f) are the indices for the lowest and highest frequency bins of frequency band f. A limiter value E_{dB_max} is formulated that is the largest of E_{dB}(n, f) over the whole data range n=1, . . . , 64 and f=1, . . . , 96. The data can then be lower-limited by

$${E}_{dB}^{′} ( n , f ) = max ( {E}_{dB} ( n , f ) , {E}_{dB\_max} - 60 )$$

The data is normalized and set to the first layer of the input data 401 by

$$I ( n , f , 1 ) = \frac{{E}_{dB}^{′} ( n , f ) - mean ( {E}_{dB}^{′} )}{std ( {E}_{dB}^{′} )}$$

where the mean (mean( )) and the standard deviation (std( )) are computed over the complete data range n=1, . . . , 64 and f=1, . . . , 96 of E′_{dB}(n, f).

The second feature of the input data 401 is the frequency map. In this example the frequency map is formulated by first determining a sequence f_{seq}(f)=f for f=1, . . . , 96 and then by normalization

$$I ( n , f , 2 ) = \frac{{f}_{s e q} ( f ) - mean ( {f}_{s e q} )}{s t d ( {f}_{s e q} )}$$

where the mean and the standard deviation are computed over the whole sequence f=1, . . . , 96.

As shown in FIG. 4 the input data 401 is provided to the first layer of the machine learning model 111. In this example the first layer of the machine learning model 111 comprises an input convolution layer 403. The input convolutional layer is configured to input an array of input data to the machine learning model 111. The input convolution layer 403 can be configured to expand the channels of the input data array into a format that is more suitable for the subsequent layers of the machine learning model 111.

In this example the input convolution layer 403 comprises 32 filters of size 1×1. The input convolution layer 403 maps the input data 401 to a 32 feature space. The output of the input convolution layer 403 has a form of 64×96×32.

The output of the input convolution layer 403 is provided to the first frequency encoder block 405₁.

The machine learning model 111 comprises a plurality of frequency encoder blocks 405. In the example of FIG. 4 the machine learning model 111 comprises four frequency encoder blocks 405. The machine learning model 111 can comprise different numbers of frequency encoder blocks 405 in other examples of the disclosure.

Each of the frequency encoder blocks 405 comprise a sequence comprising a plurality of different layers. In this example the frequency encoder blocks 405 comprise a batch normalization layer, a rectified linear unit (ReLU) and a convolution layer. Variations of these layers could be used in examples of the disclosure. For instance, in some examples the batch normalization layer could be folded to a previous operation or to a following operation. In other examples the batch normalization layer and ReLU layers could be omitted and the frequency encoder could comprise only a convolution layer with exponential linear unit (ELU) activation.

The filters of the frequency encoder blocks 405 comprise a shape of (1×3) and have stride (1,2). The filters therefore only operate on the frequency dimension. The filters do not operate on the temporal dimension. Having a filter of a size (1×3) means the convolution is performed only on the frequency dimensions. Having a stride of (1,2) means downsampling by a factor of two on the frequency dimension while the temporal dimension is not downsampled.

The frequency encoder blocks 405 operate on different numbers of output features. In the example of FIG. 4 the frequency encoder blocks 405 operate on the following number of output features:
First frequency encoder block 405₁:32;
Second frequency encoder block 405₂ 64;
Third frequency encoder block 405₃ 64;
Fourth frequency encoder block 405₄ 128.

Each frequency encoder block 405, except for the last one provides an output to the next frequency encoder block 405 and also to a corresponding level frequency de-coder block 409. The last frequency encoder block 405₄ provides the output to the recurrent temporal processing block 407. The output that is provided to the recurrent temporal processing block 407 comprises a data array with dimensions 64×6×128. As the data array has passed through the encoder blocks of the machine learning model the frequency dimension in the data array has been reduced to six.

The frequency encoder blocks do not make any combination of information along the time axis. The recurrent temporal processing block 407 is configured to receive the output data array from the last frequency encoder block 405₄ and perform convolutional long short-term memory (LSTM) processing over the time axis. The LSTM processing can be performed using a kernel size of 1×1 and 32 filters.

The LSTM comprises a recurrent unit. When the machine learning model 111 is being trained the LSTM operates on the 64 time steps of the input data 401.

When the machine learning model 111 is being used for inference, the LSTM can operate on data comprising a single temporal step. The state of the LSTM will determine the output. The LSTM will keep and/or modify its state based on new received data. This enables the LSTM to provide an output based on new input data 401 while taking prior events and data into account. Note that the procedure of using an LSTM is not the only option to take prior events and data into account, whereas a solution of using for example convolution or attention mechanisms along the time axis at any stage of the network structure is also an option.

The output of the recurrent temporal processing block 407 comprises a data array with dimensions 64×6×32. The output of the recurrent temporal processing block 407 is provided to a frequency decoder block 409₄.

The frequency decoder blocks 409 only operate on the frequency axis. One of the frequency decoder blocks 409₄ obtains an input from the recurrent temporal processing block 407. The other frequency decoder blocks 409₁-409₃ obtain two inputs. The first input is the output of a corresponding frequency encoder block 405₁-405₃. The second input is the output of the previous frequency decoder block 409.

The frequency decoder blocks 409₁-409₃ are configured to concatenate the two input data sets on the feature axis for processing. For example, the frequency decoder block 409₃ receives data from frequency encoder block 405₃. This data is provided in array having dimensions 64×12×64. The frequency decoder block 409₃ also receives an input from the previous frequency decoder block 409₄. This data is provided in an array having dimensions 64×12×128. The frequency decoder block 409₃ is configured to concatenate the two inputs to create a data array having dimensions 64×12×192.

Each of the frequency decoder blocks 409 comprise a sequence comprising a plurality of different layers. The layers in the frequency decoder blocks 409 can comprise corresponding layers to the layers in the frequency encoder blocks 405. In this example the frequency decoder blocks 409 comprise a batch normalization layer, a rectified linear unit (ReLU) and a transposed convolution layer. Variations of these layers could be used in examples of the disclosure. For instance, in some examples the batch normalization layer could be folded to a previous operation or to a following operation. In other examples the batch normalization layer and ReLU layers could be omitted and the frequency decoder could comprise only a transposed convolution layer with exponential linear unit (ELU) activation.

The filters of the frequency decoder blocks 409 comprise a shape of (1×3) and have stride (1,2). The filters therefore only operate on the frequency dimension. The filters do not operate on the temporal dimension.

The frequency decoder blocks 409 operate on different numbers of output features. In the example of FIG. 4 the frequency encoder blocks 405 operate on the following number of output features:
First frequency decoder block 409₁:32;
Second frequency decoder block 409₂ 64;
Third frequency decoder block 409₃ 64;
Fourth frequency decoder block 409₄ 128.

The output of the first frequency decoder block 409₁ comprises a data array having dimensions 64×96×32.

The output of the first frequency decoder block 409₁ is provided as an input to the output convolution layer 411. The output convolution layer 411 can be configured to convert the dimensions of the data array into a format that is more suitable for output. In the example of FIG. 4 the output convolution layer 411 is configured to apply a 1×1 convolution with one filter to convert the data array having dimensions 64×96×32 to a data array having dimensions 64×96×1.

The output of the output convolution layer 411 is provided to a sigmoid block 413. The sigmoid block 413 is configured to apply a sigmoid function to the data.

The output of the sigmoid block 413 is the output data 415 of the machine learning model 111.

Therefore, when the machine learning model 111 is being trained the machine learning model 111 receives input data in a 64×96×2 array and provides output data in a 64×96×1 array. The input data 401 comprises the spectral information and the frequency map. The output data 415 comprises the gains for each time and frequency within the input data 401.

During inference the machine learning model 111 receives input data in a 1×96×2 array. During inference the time dimension of the input data 401 is 1 and not 64. The recurrent temporal processing block 407 enables the temporal axis to be accounted for. In this case the model provides an output data in a 1×96×1 array.

The machine learning model 111 can be trained by using two or more data sets corresponding to different types of audio. The first data set can comprise sources of a first category such as speech. The second data set can comprise other noises such as ambient noise or other sounds that are not the sources of a first category. To enable training of the machine learning model 111 the different data sets are randomly mixed. The random mixing can comprise selecting items from the different sets at random and randomly temporally cropping the items. The gains for each of the selected items can be applied randomly. This can give a random signal to noise ratio for the sources of a first category. The random mixing can comprise summing the signals corresponding to the sources of a first category and the signals corresponding to the other noises. Mixing of the test data in this way can enable a mix signal and a corresponding clean signal representing the sources of a first category to be available. The audio pre-processing can also consist of any other steps, such as variations in spectrum, pitch shifts, distortions and reverberation.

The mixed data sets can be used to formulate the spectral input of the input data 401. This is provided to the machine learning model 111 to enable the machine learning model 111 to predict output data 415. The output data 415 can be used as the gains in each frequency band that are to be used to process the mixed audio signals. The training enables the machine learning model 111 to predict useful gain values.

In some examples the mixed data sets can comprise PCM signals. The PCM signals can have a suitable sampling rate such as 48 KHz. The PCM signals are converted to the time-frequency domain. The PCM signals can be converted to the time-frequency domain by using a short-time Fourier transform (STFT). The STFT can have a sine window, hop size of 1024 samples and FFT size of 2048 samples. The conversion to the time-frequency domain results in a time-frequency signal having 1025 unique frequency bins and 64 time steps, when the length of the mixed data set PCM signals is (64+1)*1024 samples. The frequency bin data can then be converted to the first feature part of input data 401 for the machine learning model 111.

When the output data 415 has been obtained from the machine learning model 111 this can be used to process the time-frequency signal having 1025 unique frequency bins. The output data 415 comprises the predicted gains for the different frequency bins. The output data 415 can comprise 96 values so each f:th gain is used to process the frequency bins at the range from b_{low}(f) to b_{high}(f). This can be used to suppress sounds that are not from the sources of a first category.

To enable the training of the machine learning model 111 a loss function can be defined. The loss function provides a value that defines how well the machine learning model 111 is predicting the desired result. To define the loss function, a difference signal is formulated between the ground truth source of a first category signal and the gain-processed mixture. The ground truth source of a first category signal can comprise a clean reference signal comprising the sources of a first category. The loss function formulates the energy of the difference signal with respect to the energy of the mixture in decibels. An Adam optimizer with a learning rate of 0.001 and batch size of 120 can applied during the training.

The training of the machine learning model 111 causes the network weights within the machine learning model 111 to converge. The converged network weights can then be stored in the memory 105 as shown in FIGS. 1 and 2.

In some examples a machine learning model 111 having a specific architecture can be trained and then a different machine learning model 111 having a different architecture can be derived from the trained machine learning model 111. Any suitable processes can be used to derive the different machine learning model 111. For example, processes such as compilation, pruning, quantization or distillation can be used to derive the different machine learning model 111.

FIG. 5 shows an example method. The method could be performed by the processor 103 in the electronic device 201 as shown in FIG. 2 or by any other suitable apparatus.

The processor 103 can receive audio signals 205 as an input. The audio signals 205 comprise audio signals that are output by the microphones 203. The audio signals comprise data that represent sound. The processor 103 can receive two or more audio signals 205 as an input. The two or more audio signals 205 are received from two or more microphones 203 that are configured to enable spatial audio to be captured.

The audio signals 205 are provided to a time-frequency transform block 501. The time-frequency transform block 501 is configured to apply any suitable time-frequency transform to convert the audio signals 205 from the time domain. The audio signals 205 can be converted from the time domain to frequency bands.

In the example of FIG. 5 the time-frequency transform block 501 uses a STFT. The STFT uses a sine window, a hop size of 1024 samples and Fast Fourier Transform (FFT) and window size of 2048 samples. Other types of transform and configurations for the transform could be used in other examples.

The time-frequency transform block 501 provides an output comprising time-frequency signals 503. The time frequency signals 503 can be written as S(n, b, i) where b=1, . . . , N_{bins} is the frequency bin index, and i=1, . . . , N_{ch} is the channel index and n=1, . . . , num_T is the temporal index. In this example the time frequency signals 501 comprise 1025 unique frequency bins for each time step and channel. In this example the temporal index n is not limited to range 1 . . . 64 as it is in the training phase.

The time frequency signals 503 are provided as an input to a spatial information estimator (and spatial filter) block 505. The spatial information estimator can estimate the direction of arrival of sounds or other spatial information. In this example the spatial information that is estimated can comprise a steering vector. Other types of spatial information could be estimated in other examples.

The spatial information estimator block 505 also receives the trained machine learning model 111 as an input. The trained machine learning model 111 can be retrieved from the memory 105 or accessed from any other suitable location.

The spatial information estimator block 505 is configured to use the machine learning model to determine spatial information relating to one or more sources of a first category within the audio signals 205. The spatial information estimator block 505 can also comprise a spatial filter. FIG. 6 shows an example of a method that can be performed by a spatial information estimator block 505.

In some examples the spatial information estimator block 505 can be configured to use the machine learning model 111 to determine spatial information for the sources of a first category. The spatial information can comprise a steering vector or any other suitable type of information.

The spatial information estimator block 505 can be configured to formulate a remainder covariance matrix. The spatial information estimator block 505 can use the remainder covariance matrix and the spatial information to formulate beamforming weights. The beamforming weights can be applied to the time-frequency (microphone) signals 503 to obtain a signal that emphasizes the sources of a first category. This provides a portion of the audio signal based on the sources of a first category.

The spatial information estimator block 505 can also use the output of the trained machine learning model 111 to filter the time-frequency (microphone) signals 503 or the beamformer output to improve the spectrum of the sources of a first category. The machine learning model 111 that is used to filter the time-frequency (microphone) signals can be the same as the machine learning model that is used to obtain the spatial information or could be a different machine learning model 111.

The spatial information estimator block 505 provides spatial information 507 as a first output. The spatial information 507 can comprise a steering vector or any other suitable spatial information.

The spatial information can comprise an approximation of the response of the sources of a first category to the microphones 203, i.e., the steering vector. The spatial information can comprise a steering vector which can be denoted as V(n, b, i).

The spatial information estimator block 505 can also provide source of a first category signals 509 as a second output. The source of a first category signals 509 comprise a sources of a first category portion of the input data. The source of a first category signals 509 can be time-frequency signals. The source of a first category signals 509 can be denoted as Sᵢₙₜₑᵣₑₛₜ(n, b). The source of a first category signals 509 comprise only one channel as a result of the beamforming applied by the spatial information estimator block 505.

The spatial information 507 and the source of a first category signals 509 are provided as an input to a source of a first category positioner block 511. The source of a first category positioner block 511 is configured to use the spatial information 507 to position the source of a first category signals 509 with the respect to the plurality of microphones 203 so as to mimic the situation of the source of a first category signals 509 arriving from a position corresponding to the steering vector or other spatial information 507.

$${S}_{interest , pos} ( n , b , i ) = {S}_{i n t e r e s t} ( n , b ) V ( n , b , i )$$

The S_{interest,pos}(n, b, i) is the positioned source of a first category signal 513. The positioned source of a first category signal 513 is provided as an output from the source of a first category positioner block 511.

The positioned source of a first category signal 513 is provided as an input to a mixer module 515. The mixer module 515 also receives the time frequency (microphone) signals 503 as an input. The time frequency signals 503 can be received from the time-frequency transform block 501. The mixer module 515 is configured to mix the time frequency signals 503 and the positioned source of a first category signal 513. The mixer module 515 is configured to mix the time frequency signals 503 and the positioned source of a first category signal 513 according to a mix-ratio parameter a. The mix-ratio parameter a can have any value between 0 and 1. For example, the mix-ratio parameter a could be 0.5.

$${S}_{m i x} ( n , b , i ) = α {S}_{interest , pos} ( n , b , i ) + ( 1 - α ) S ( n , b , i )$$

If α=0 then the component comprising the positioned source of a first category signal 513 is zero. In such cases the signal would effectively be processed without using the examples of the disclosure. If α=1 the component comprising the time frequency signals 503 is set to zero. In this case the input data is maximally processed, or substantially maximally processed to remove as much of the unwanted sounds as possible. If α=0.5 then some of the unwanted elements would be attenuated but the sources of a first category could be preserved.

The mixer block 515 provides a time-frequency mix signal 517 as an output. The mix signal 517 can be denoted as Sₘᵢₓ(n, b, i). The mix signal 517 can provided as an input to a spatial audio processing block 519.

The spatial audio processing block 519 is configured to perform spatial audio processing on the mix signal 517. The spatial audio processing can comprise any suitable procedures for enabling the spatial effects to be reproduced. For example, the spatial audio processing block may process a binaural audio output based on the mix signals 517.

The spatial audio processing bock 519 can be configured to use existing procedures. The existing procedures are suitable for use because the processing of the sources of a first category portion of the audio signals retains the original position of the sources of a first category within the mix signal 517. This means that it retains the inter-microphone amplitude and phase differences which is the information that is typically used by existing spatial audio processing procedures.

As an example, the spatial audio processing block 519 could be configured to determine spatial metadata such as directions DOA(n, k) and direct-to-total energy ratios r(n, k) in frequency bands based on the mix signal Sₘᵢₓ(n, b, i). The parameters of the spatial metadata can then be used to render a spatial audio output signal based on the mix signal Sₘᵢₓ(n, b, i). In this example we have denoted k as a frequency band index. It has an equivalent meaning as the frequency band f in that each band can comprise one or more bins b, However the resolution of the frequency bands may be different.

In some examples lower frequency resolution may be sufficient for determining spatial metadata when compared to the frequency resolution that is used to identify the different portions.

In some examples the electronic device 201 can be configured to provide a binaural output. In such cases the spatial audio processing block 519 can be configured to use head-related transfer functions (HRTFs) in frequency bands. The HRTFs can be used to position the direct energetic proportion r(k, n) of the audio signals 205 to the direction of DOA(k, n), and to process the ambient energetic proportion 1-r(k, n) of the audio signals 205 as spatially unlocalizable sound. Decorrelators that are configured to provide appropriate diffuse field binaural inter-aural correlation can be used to process the ambient energetic proportion as spatially unlocalizable sound. The processing can be adapted for each frequency and time interval (k, n) as determined by the spatial metadata.

In some examples the electronic device 201 can be configured to provide an output for a loudspeaker. In such examples the direct portion of the audio signals 205 can be rendered using a panning function for the target loudspeaker layout. The ambient portion of the audio signals 205 can be rendered to be incoherent between the loudspeakers.

In some examples the electronic device 201 can be configured to provide an Ambisonic output. In such cases the examples the direct portion of the audio signals 205 can be rendered using an Ambisonic panning function. The ambient portion of the audio signals 205 can be rendered to be incoherent between the output channels with levels in accordance with the Ambisonic normalization scheme that has been used.

After the spatial processing has been performed the spatial audio processing block 519 can be configured to apply an inverse time-frequency transform. In this example the inverse time-frequency transform would be an inverse STFT. The spatial audio processing block 519 provides the spatial audio output 207 as an output. This can be provided to storage 209 and/or to a transceiver 211 as shown in FIG. 2.

In some examples the electronic device 201 could be a different type of device. For instance, instead of a mobile phone the electronic device 201 could be a microphone array. The microphone array could be a first order or Ambisonic microphone array or any other suitable type of microphone array. In such examples the audio signals 205 would be processed as an Ambisonics audio signal. The method performed by the processor 103 would be similar to the method shown in FIG. 5 however the spatial audio processing block 519 would use appropriate methods to obtain the spatial metadata. For example, Directional Audio Coding (DirAC) could be used to determine direction information and a ratio value indicating how directional or non-directional the sound is. This direction information and ratio can be determined for a plurality of frequency bands. Once an appropriate method has been used to determine the spatial metadata the spatial audio processing can be implemented as described above.

In some examples the electronic device 201 does not itself contain the microphones 203 providing the audio signals 205, but the audio signals 205 are received from another device for processing with the electronic device 201. In some examples the audio signals 205 comprise a set of simulated microphone capture signals or other signals that do not necessarily correspond to any physical microphone array, but can nevertheless be considered as having characteristics of a set of audio signals. For example, the signals can comprise different directivity characteristics for each channel. The audio signals 205 could be a set of Ambisonic signals, where each of the Ambisonic channels (i.e., channel signals) have a different defined spatial directivity pattern. In some examples, in particular when the audio signals 205 are Ambisonic signals, the spatial audio processing block 519 may be omitted, or can consist of only an inverse time-frequency transform, since the processed Ambisonic signal (that is, the mix signal 517) is already a spatial audio signal. In such cases, the reproduction of the Ambisonic signal to binaural or surround loudspeaker signals may be performed by an external Ambisonic decoder at the electronic device 201 or at another device.

In some examples the spatial audio processing block 519 can be configured to generate an audio signal and corresponding spatial metadata. In such examples the spatial audio processing block 519 can generate a transport audio signal such as a left-right stereo signal based on the mix audio signals Sₘᵢₓ(n, b, i). In examples where the electronic device 201 is a mobile phone, or other similar device, the transport audio signals can be generated by selecting left microphones and right microphones from the available channels.

In examples where the mix signal 517 that is output by the mixer 515 comprises Ambisonics signals then the process for generating transport audio signals can comprise beamforming. For example, left and right spatial capture patterns that are based on the Ambisonic audio signal can be generated to create the transport audio signals. The spatial capture patterns could be cardioid patterns or any other suitable shaped patterns. The spatial metadata for the Ambisonics signals could be determined as described above.

Once the transport audio signals have been generated the transport audio signals and the spatial metadata could be encoded and multiplexed to an encoded audio stream such as an IVAS stream. The IVAS stream would then provide a spatial audio output 207.

FIG. 5 shows an example method that can be implemented by the processor 103. The processor 103 can also implement other methods and procedures that are not shown in FIG. 5. For example, the processor 103 can be configured to enable other types of audio processing such as equalization, automatic gain control and limiting. The spatial audio processing block 519 can also implement other methods and procedures that are not shown in FIG. 5. For example, the spatial audio processing block 519 can enable beamforming and other spatial filtering procedures.

FIG. 6 shows an example method that could be performed by a spatial information estimator block 505 as shown in FIG. 5.

The time-frequency signals 503 are provided as an input to the spatial information estimator block 505. The time-frequency signals 503 can be provided from a time-frequency transform block 501 as shown in FIG. 5 or from any other suitable source.

The time-frequency signals 503 are provided as an input to a first mask estimator 601. The first mask estimator 601 also receives a trained machine learning model 111₁ as an input. The trained machine learning model 111₁ can be stored in the memory 105 or can be accessed from any other suitable location.

The first mask estimator 601 can be configured to estimate input data 401 for the machine learning model 111₁. The input data 401 can be denoted as I(n, f, c) as described above. The input data 401 that is used for inference by the machine learning model 111₁ differs from the input data 401 that is used to train the machine learning model 111₁. A first difference is that the time dimensions for the input data 401 used for inference is in a typical configuration only 1, in other words, one temporal step is processed at a time to minimize latency. The input data 401 I(n, f, c) that is processed using the trained machine learning model 111₁ is only one temporal n:th sample and comprises a data array having dimensions 1×96×2. The second difference is that when the input data is used for inference the normalization is performed using a running average rather than over a sequence of 64 samples.

These differences in the input data require corresponding modifications to some of the above-mentioned equations.
1. The max value E_{dB_max}(n) for the bottom limitation can be obtained by keeping the values E_{dB}(n, f) over the last 64 temporal indices (that is, for range n-63, . . . , n), and selecting the largest of them. E′_{dB}(n, f) can be formulated as described previously.
2. The mean can be formulated by

$${E}_{d {B}_{-} m e a n}^{′} ( n ) = ( 1 - β ) \frac{1}{{N}_{f}} {\sum }_{f = 1}^{{N}_{f}} {E}_{d B}^{′} ( n , f ) + β {E}_{d {B}_{-} m e a n}^{′} ( n - 1 )$$

where N_{f}=96; β is an infinite impulse response (IIR) averaging factor, for example 0.99, and E′_{dB_mean}(0)=0, or other defined value.
3. The variance can be formulated by

$${E}_{d {B}_{-} v a r}^{′} ( n ) = ( 1 - β ) \frac{1}{{N}_{f}} {\sum }_{f = 1}^{{N}_{f}} {[ {E}_{d B}^{′} ( n , f ) - {E}_{d {B}_{m e a n}}^{′} ( n ) ]}^{2} + β {E}_{d {B}_{-} v a r}^{′} ( n - 1 )$$

where E′_{dB_var}(0)=0, or other defined value.
4. The standard deviation is then

$${E}_{d {B}_{-} s t d}^{′} ( n ) = \sqrt{{E}_{dB\_var}^{′} ( n )}$$

5. The first feature of the input data 401 is then

$$I ( n , f , 1 ) = \frac{{E}_{d B}^{′} ( n , f ) - {E}_{d {B}_{-} m e a n}^{′} ( n )}{{E}_{d {B}_{-} s t d}^{′} ( n )}$$

Accounting for these differences the generation of the input data 401 is similar to the generation of the input data 401 for the training of the machine learning model 111 as described above. Typically, when using recurrent blocks such as LSTM within the machine learning model 111, the networks are trained as stateless (the network does not keep memory between different input sequences for training), and are used in inference as stateful (the network has a state caused by previous input signals).

The machine learning model 111₁ provides an output that can be denoted O₁(f). In this notation the unity dimensions have been discarded. The output O₁(f) provides a mask 603. The mask 603 is the output of the first mask estimator 601.

The mask that is estimated by the first s mask estimator 601 provides a filter comprising processing gains. The processing gains can be real gains or complex gains. In this example the processing gains are real gains.

The gain values of the mask can relate to values in time and/or frequency. The value of the gain values within the mask 603 are dependent upon the proportion of sources of a first category within the corresponding time-frequency regions of the audio signals. For example, if a time-frequency region relates only to sources of a first category then the mask value for that region would ideally be 1. Conversely if a time-frequency region relates only to noise or unwanted sounds then the mask value for that region would ideally be 0. If the time-frequency region relates to a mix of both sources of a first category and unwanted noise then the mask value would ideally be an appropriate value between 0 and 1.

The mask 603 is provided as an input to the source of a first category and remainder separator 605. The source of a first category and remainder separator block 605 also receives the time-frequency signals 503 as an input. The source of a first category and remainder separator 605 can be configured to separate the time-frequency signals 503 into sources of a first category and a remainder.

The source of a first category and remainder separator block 605 uses the mask 603 and the time-frequency signals 503 to generate a mask processed time-frequency signal for the sources of a first category 607. The mask processed time-frequency signal for the sources of a first category 607 can be denoted S_{interestM}(n, b, i) where

$${S}_{i n t e r e s t M} ( n , b , i ) = S ( n , b , i ) {O}_{1} ( f )$$

Where O₁(f) denotes the mask 603 and S(n, b, i) denotes the time-frequency signal 503 and where band f is the band where bin b resides.

The source of a first category and remainder separator block 605 also uses the mask 603 and the time-frequency signals 503 to generate a mask processed time-frequency signal for the remainder 609. The mask processed time-frequency signal for the remainder 609 can be denoted S_{remainderM}(n, b, i) where

$${S}_{r e m a i n d e r M} ( n , b , i ) = S ( n , b , i ) ( 1 - {O}_{1} ( f ) )$$

where band f is the band where bin b resides.

The source of a first category and remainder separator block 605 provide the mask processed time-frequency signals 607, 609 as outputs.

The mask processed time-frequency signal for the sources of a first category 607 is provided as an input to a steering vector estimator 611. The steering vector estimator is configured to obtain spatial information from the mask processed time-frequency signals 607. In the example of FIG. 6 the steering vector estimator 611 uses the mask processed time-frequency signal for the sources of a first category 607 to estimate a steering vector. Other types of spatial information could be obtained from the mask processed time-frequency signal for the sources of a first category 607 in other examples of the disclosure.

Any suitable process can be used to determine the steering vector. In some examples the steering vector estimator 611 can first formulate a covariance matrix for the sources of a first category. The covariance matrix can be denoted Cₛ(n, b) where:

$${C}_{s} ( n , b ) = ( 1 - {γ}_{s} ) {s}_{inte r e stM} ( n , b ) {{s}_{i n t e r e s t M}^{H} ( n , b )}_{} + {γ}_{s} {C}_{s} ( n - 1 , b )$$

where γₛ is a temporal smoothing coefficient. The temporal smoothing coefficient can have a value between 0 and 1, for example the temporal smoothing coefficient can have a value of 0.8 or any other suitable value. Cₛ(0, b) can be a matrix of zeros, and s_{interestM}(n, b) can be a column vector having the channels of signal S_{interestM}(n, b, i) as its rows.

The steering vector estimator 611 applies an eigendecomposition to the covariance matrix Cₛ(n, b), and obtains the eigenvector u(n, b) that corresponds to the largest eigenvalue. The eigenvector is then normalized with respect to its first channel by

$$v ( n , b ) = \frac{u ( n , b )}{U ( n , b , 1 )}$$

where U(n, b, 1) is the first row entry of u(n, b). The vector v(n, b) is then the estimated steering vector of the sources if interest. The steering vector v(n, b) comprises the steering vector values V(n, b, i) at its rows. The steering vector v(n, b) can vary in time and frequency. In some examples of the disclosure, when the audio signals correspond to coincident capture patterns (for example, Ambisonic patterns), one same steering vector could be defined for multiple or all bins b.

The steering vector estimator 611 provides the steering vector 613 as an output. The steering vector can be denoted in the vector form as v(n, b) or in the entry form as V(n, b, i).

The remainder covariance matrix estimator 615 is configured to estimate a covariance matrix for the remainder portion of the signals that comprise the unwanted sounds. The remainder covariance matrix estimator 615 receives the mask processed time-frequency signal for the remainder 609 as an input. The covariance matrix can be estimated based on the mask processed time-frequency signal for the remainder 609. The remainder covariance matrix Cᵣ(n, b) can be given by:

$${C}_{r} ( n , b ) = ( 1 - {γ}_{r} ) {s}_{r e m a i n d e r M} ( n , b ) {s}_{r e m a i n d e r M}^{H} ( n , b ) + {γ}_{r} {C}_{r} ( n - 1 , b )$$

where γᵣ is a temporal smoothing coefficient. The temporal smoothing coefficient can have a value between 0 and 1, for example the temporal smoothing coefficient can have a value of 0.8 or any other suitable value. Cᵣ(0, b) can be a matrix of zeroes and s_{remainderM}(n, b) can be a column vector having the channels of signal S_{remainderM}(n, b, i) as its rows.

The remainder covariance matrix estimator 615 provides the remainder covariance matrix 617 as an output.

A beamformer 619 receives the time-frequency signals 503, the steering vector 613 and the remainder covariance matrix 617 as inputs. The beamformer can use the inputs to perform beamforming on the time-frequency signals 503. The beamformer 619 can use any suitable process for beamforming. For instance, the beamformer 619 could use minimum variance distortionless response (MVDR) or any other suitable process.

The beamformer 619 can obtain beamforming weights w(n, b) where:

$$w ( n , b ) = {C}_{r}^{- 1} ( n , b ) \frac{v ( n , b )}{{v}^{H} ( n , b ) {C}_{r}^{- 1} ( n , b ) v ( n , b )}$$

The beamformer 619 can then apply the beamform weights to the time-frequency signal 503 to provide the beam time-frequency signal 621. The beam time-frequency signal 621 is given by

$${S}_{b e a m} ( n , b ) = {w}^{H} ( n , b ) s ( n , b )$$

where s(n, b) is a column vector having the channels of signal S(n, b, i) as its rows. The beamformer 619 then provides the beam time-frequency signal 621 as an output. In some examples of the disclosure the beamformer 619 also applies a beamformer post-filter, i.e., gains in frequency bins, to further match the spectrum of S_{beam}(n, b) to the sound arriving to the array from the direction corresponding to the steering vector v(n, b).

The beam time-frequency signal 621 is provided as an input to the second mask estimator 623. The second mask estimator 623 also receives a trained machine learning model 111₂ as an input. The trained machine learning model 111₂ can be stored in the memory 105 or can be accessed from any other suitable location.

In the present example, the second trained machine learning model 111₂ can be the same as the first trained machine learning model 111₁ that is provided to the first mask estimator 601. In other examples the second trained machine learning model 111₂ could be different to the first trained machine learning model 111₁ and/or could be trained differently to the first trained machine learning model 111₁.

The second mask estimator 623 can perform similar functions to the first mask estimator 601 except that the second mask estimator 623 receives the beam time-frequency signal 621 as an input instead of the time-frequency signals 503. The second mask estimator 623 also only has one channel.

The second mask estimator 623 provides a second mask 625 as its output. The second mask 625 can be denoted as O₂(f).

The gain processing block 627 receives the beam time-frequency signal 621 and the second mask 625 as inputs. The gain processing block 627 processes the beam time-frequency signal 621 with the second mask 625. The gain processing block 627 can use a similar process to the source of a first category and remainder separator, as described above, to process the beam time-frequency signal 621 with the second mask 625. The gain processing block 627 provides a mask processed time-frequency signal for the sources of a first category signal 509. The mask processed time-frequency signal for the sources of a first category signal 509 can be denoted as Sᵢₙₜₑᵣₑₛₜ(n, b) where

$${S}_{interest} ( n , b ) = {S}_{b e a m} ( n , b ) {O}_{2} ( f ) .$$

The method of FIG. 6 therefore provides the source of a first category signal 509 and the steering vectors 613 as an output. Other types of spatial information could be used in other examples of the disclosure.

In this example the machine learning models 111 are used to estimate a mask and the mask is then applied to a signal to provide a masked signal. Other configurations for the machine learning models 111 could be used in other examples. For instance, the machine learning models 111 could be configured to determine the mask-processed signal directly.

FIG. 7 shows an example method. The method could be performed by the processor 103 in the electronic device 201 as shown in FIG. 2 or by any other suitable apparatus. The example method of FIG. 7 could be an alternative to the method shown in FIG. 5.

Blocks 501 to 511 of the method in FIG. 7 can be the same as shown in FIG. 5 and described above. The processor 103 can receive audio signals 205 as an input to a time-frequency transform block 501. The time-frequency transform block 501 is configured to apply any suitable time-frequency transform to convert the audio signals 205 from the time domain. The time-frequency transform block 501 provides an output comprising time-frequency signals 503. The time frequency signals 503 are provided as an input to a spatial information estimator block 505. The spatial information estimator block 505 also receives the trained machine learning model 111 as an input.

The spatial information estimator block 505 provides spatial information 507 as a first output. The spatial information 507 can comprise a steering vector or any other suitable spatial information.

The spatial information estimator block 505 can also provide source of a first category signals 509 as a second output.

The spatial information 507 and the source of a first category signals 509 are provided as an input to a source of a first category positioner block 511. The source of a first category positioner block 511 is configured to use the spatial information 507 to position the source of a first category signals 509 with the respect to the plurality of microphones 203 so as to mimic the situation of the source of a first category signals 509 arriving from a position corresponding to the steering vector or other spatial information 507. The positioned source of a first category signal 513 is provided as an output from the source of a first category positioner block 511.

The positioned source of a first category signal 513 is provided as an input to a remainder generator block 701. The remainder generator block 701 also receives the time frequency signals 503 as an input. The remainder generator block 701 is configured to create a remainder time frequency signal 703. The remainder time frequency signal 703 comprises the sound other than the sources of a first category that are comprised within the positioned source of a first category signal 513. The remainder time frequency signal 703 can be denoted as S_{remainder,pos}(n, b, i).

The remainder time frequency signal 703 can be generated using any suitable process. For example, it can be generated by subtracting the positioned source of a first category signal 513 from the time frequency signals 503.

$${S}_{r e m a i n der , pos} ( n , b , i ) = S ( n , b , i ) - {S}_{speech , pos} ( n , b , i ) .$$

The remainder time frequency signal 703 still contains appropriate inter-microphone level and phase differences for the remainder sounds. This enables the remainder time frequency signal 703 to be used for spatial audio analysis and synthesis. This enables the sounds corresponding to unwanted sources and/or ambient sounds to be spatialised.

The positioned source of a first category signal 513 is provided as an input to a first spatial audio processing block 705. The first spatial audio processing block 705 can spatialize the positioned source of a first category signal 513 as described above in relation to FIG. 5. The first spatial audio processing block 705 provides source of a first category spatial audio 709 as an output. The source of a first category spatial audio 709 could be binaural audio signals or any other suitable type of signal. The source of a first category spatial audio 709 can be denoted as sᵢₙₜₑᵣₑₛₜ(t, i) where t is the temporal sample index.

The remainder time frequency signal 703 is provided as an input to a second spatial audio processing block 707. The second spatial audio processing block 707 can spatialize the remainder time frequency signal 703 as described above in relation to FIG. 5. The second spatial audio processing block 707 provides remainder spatial audio 711 as an output. The remainder spatial audio 711 could be binaural audio signals or any other suitable type of signal. The remainder spatial audio 711 can be denoted as s_{remainder}(t, i) where t is the temporal sample index.

The source of a first category spatial audio 709 and the remainder spatial audio 711 are provided as inputs to a spatial audio mixer block 713. The spatial audio mixer block 713 combines the source of a first category spatial audio 709 and the remainder spatial audio 711. Any suitable process can be used to combine the source of a first category spatial audio 709 and the remainder spatial audio 711. In some examples the combination can be controlled so that the remainder spatial audio 711 is attenuated by a selected amount. The selected amount can be controlled by using an adjustable factor β. In some examples the combination can be performed by summing the source of a first category spatial audio 709 and the remainder spatial audio 711 to give the spatial audio output signal 715. The spatial audio output signal 715 can be denoted sₒᵤₜ(t, i).

$${s}_{o u t} ( t , i ) = {s}_{i n t e r est} ( t , i ) + β {s}_{r e m a i n d e r} ( t , i ) .$$

When the value of β=1, the remainder spatial audio 711 is not attenuated at all. In such examples the sources of a first category would not be increased in volume relative to the unwanted sounds. However, even with setting β=1 the example of FIG. 7 provides for improved source stability because it enables the sources of a first category to be rendered separately to the remainder of the sound.

When the value of β=0, the remainder spatial audio 711 is fully attenuated.

In examples of the disclosure the adjustable factor β could take any value between 0 and 1. For example, if β=0.5 this could attenuate the remainder spatial audio 711 by a given amount while keeping the source of a first category spatial audio 709 unmodified.

FIG. 8 shows an example method. The method could be performed by the processor 103 in the electronic device 201 as shown in FIG. 2 or by any other suitable apparatus. The example method of FIG. 8 could be an alternative to the methods shown in FIGS. 5 and 7.

Blocks 501 to 701 of the method in FIG. 8 can be the same as shown in FIG. 7 and described above. Corresponding reference numerals are used for corresponding features.

In the example of FIG. 8 the positioned source of a first category signal 513 is provided as an input to a first spatial audio analysis block 801. The first spatial audio analysis block 801 performs the spatial analysis of the source of a first category signal 513 but does not perform any synthesis. The spatial analysis can be similar to the spatial analysis that is performed by the first spatial audio processing block 705 as shown in FIG. 7.

The first spatial audio analysis block 801 provides source of a first category spatial audio stream 805 as an output. The source of a first category spatial audio stream 805 could comprise transport audio signals and associated spatial metadata. The transport audio signals can be denoted as s_{interest,trans}(t, i). The spatial metadata can comprise direction information and direct-to-total energy ratios and/or any other suitable information.

The remainder time frequency signal 703 is provided as an input to a second spatial audio analysis block 803. The second spatial audio analysis block 803 performs the spatial analysis of the remainder time frequency signal 703 but does not perform any synthesis.

The second spatial audio analysis block 803 provides remainder spatial audio stream 807 as an output. The remainder spatial audio stream 807 could comprise transport audio signals and associated spatial metadata. The transport audio signals can be denoted as s_{remainder,trans}(t, i). The spatial metadata can comprise direction information and direct-to-total energy ratios and/or any other suitable information.

The source of a first category spatial audio stream 805 and the remainder spatial audio stream 807 are provided as input to a spatial audio stream mixer block 809. The spatial audio stream mixer block 809 combines the source of a first category spatial audio stream 805 and the remainder spatial audio stream 807. Any suitable process can be used to combine source of a first category spatial audio stream 805 and the remainder spatial audio stream 807. In some examples the combination can be controlled so that the remainder spatial audio stream 807 is attenuated by a selected amount. The selected amount can be controlled by using an adjustable factor β. In some examples the combination can be performed by summing the source of a first category spatial audio stream 805 and the remainder spatial audio stream 807 to give the spatial audio stream output signal 811. The spatial audio output signal 811 can be denoted sₒᵤₜ(t, i).

$${s}_{o u t} ( t , i ) = {s}_{speech , trans} ( t , i ) + β {s}_{r e m a i n d e r , t r a n s} ( t , i ) .$$

The adjustable factor β can have a value between 0 and 1 as described above.

In the example of FIG. 8 the spatial audio stream mixer block 809 is also configured to combine the spatial metadata from the source of a first category spatial audio stream 805 and the remainder spatial audio stream 807. Any suitable process can be used to combine the spatial metadata. In some example two-direction spatial metadata can be produced. This assumes that the original spatial metadata streams were single-direction. In such examples two directions are indicated for each time-frequency tile, and these are the directions of the source of a first category and remainder streams

$${θ}_{1} ( n , k ) = {θ}_{i n t e r e s t} ( n , k ) {θ}_{2} ( n , k ) = {θ}_{r e m a i n d e r} ( n , k )$$

where θ is the direction parameter.

In this case, the direct-to-total energy ratios are also modified based on the stream energies and the adjustable factor β factor. For example, the direct-to-total energy ratios could be adjusted by:

$${r}_{1} ( n , k ) = \frac{{E}_{i n t e r est} ( n , k ) {r}_{interest} ( n , k )}{{E}_{i n t e r est} ( n , k ) + {β}^{2} {E}_{remainder} ( n , k )} \\ {r}_{2} ( n , k ) = \frac{{β}^{2} {E}_{r e m a i n d e r} ( n , k ) {r}_{r e m a i n d e r} ( n , k )}{{E}_{i n t e r est} ( n , k ) + {β}^{2} {E}_{remainder} ( n , k )}$$

where r is the direct-to-total energy ratio parameter and E is the energy. The energy can be computed using the transport audio signals or by any other suitable process. For example, the energy for the source of a first category and remainder transport signals at band k can be a sum of the energies of the frequency bins within that band, for the corresponding transport signals.

The spatial audio stream mixer block 809 provides a spatial audio stream output 811 as an output. The spatial audio stream output 811 can be provided to a spatial synthesis block to enable spatial audio signals, such as binaural audio signals, to be produced. The spatial audio stream output 811 can be stored in storage 209 and/or can be provided to a transceiver 211. The spatial audio stream output 811 can be synthesized to other spatial audio signals such as binaural or surround loudspeaker signals at a later time and/or by a different electronic device.

In this example, even if the adjustable factor β is set to 1 this will still provide for improved audio quality even though the remainder portion of the signal is not attenuated. In such cases the source of a first category portion has independent spatial metadata from the remainder portion which provides for improved stability and localization of the sources of a first category.

FIG. 9 shows example outputs that can be obtained using examples of the disclosure. FIG. 9 compares an example output obtained using examples of the disclosure to outputs obtained using different processes.

Five different columns are shown in FIG. 9. The different columns show different channels of four multi-channel loudspeaker signals represented by the rows. The first column 901 shows left channel loudspeaker signals, the second column 903 shows right channel loudspeaker signals, the third column 905 shows centre channel loudspeaker signals, the fourth column 907 shows left surround channel loudspeaker signals and the fifth column 909 shows right surround channel loudspeaker signals.

FIG. 9 also shows four different rows. The different rows show results obtained using different processes.

The first row 911 shows a reference signal (an ideal noiseless clean target signal) for each of the channels, one channel at a time. The second row 913, third row 915 and fourth row 917 each show a situation in which the following is performed:
An electronic device 201 with three microphones 203 (where the microphones 203 are approximately as shown in FIG. 2) captures the reference sound scene at the center listening position in an anechoic acoustic environment, where the reference sound scene is generated by reproducing the reference signal 911 as point sources from left, right, centre, left surround and right surround directions. An additional noise source is placed at the direction of the left surround loudspeaker at an angular direction of around 110 degrees.
Capture processing is performed to the audio signals 205 from the three microphones 203 to generate a mono or 5.0 surround output. When rendering 5.0 sound, which is the same format as the original reference input, spatial metadata (comprising directions and ratios in frequency bands) is determined based on the audio signals 205 and the sound is rendered to the surround loudspeaker setup based on that spatial metadata.

The second row 913 shows a spatial enhanced mode in which the processing comprises spatial speech enhanced processing according to the example of FIG. 5.

The third row 915 shows a mono enhanced mode. In this mode the speech enhancement procedures of the spatial enhanced mode are used but the output is rendered in a mono output. The plots in the third row 915 shows the audio signal at the first channel. In this case this does not mean a “left” loudspeaker output but indicates a mono output. This shows an example of providing a clean mono speech signal without any spatialization aspects.

The fourth row 917 shows a spatial un-enhanced mode. This shows an example where the audio processing comprises metadata based spatial processing without any of the speech, or other sources of a first category, enhancement procedures as described in this disclosure.

FIG. 9 shows that the spatial enhance mode of the example of the disclosure enables both the spatial audio reproduction and effective speech enhancement.

FIG. 9 shows that in both of the spatial modes there is a slight leakage from the source direction to other directions. This can be common in electronic devices 201 such as mobile phones which have limited arrangements of microphones 203 as compared to capture audio systems that are dedicated for audio capture. This slight leakage does not typically cause errors in localization perception because the speech is predominantly reproduced at the correct direction. Especially the column 901 for the left channel and the column 907 for the left surround channel show the difference between the spatial enhanced mode 913 which has suppressed the noise interferer and spatial un-enhanced mode 917 which has significant presence of the noise interferer.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. An apparatus, comprising:
at least one processor; and
at least one memory storing instructions that, when executed with the at least one processor, cause the apparatus at least to:
obtain input data for a trained machine learning model wherein the input data is based on audio signals from two or more microphones configured for spatial audio capture;
determine, using the input data and the trained machine learning model, spatial information relating to one or more sources of at least a first category captured within the audio signals;
separate, at least partially, a portion of the audio signals corresponding to the one or more sources of at least the first category from a remainder of the audio signals; and
process the portion corresponding to the one or more sources of at least the first category based on the spatial information determined using the trained machine learning model and process at least the remainder of the audio signals based on information in the two or more audio signals.

2. An apparatus as claimed in claim 1, wherein the instructions, when executed with the at least one processor, cause the apparatus to increase the relative volume of the one or more sources of at least the first category compared to the remainder.

3. An apparatus as claimed in claim 1, wherein the instructions, when executed with the at least one processor, cause the apparatus to use the trained machine learning model is used to separate, at least partially, the portion of the audio signals corresponding to the one or more sources of at least the first category from the remainder of the audio signals.

4. An apparatus as claimed in claim 1, wherein the instructions, when executed with the at least one processor, cause the apparatus to use a different machine learning model to separate, at least partially, the portion of the audio signals corresponding to the one or more sources of at least the first category from the remainder of the audio signals.

5. An apparatus as claimed in claim 1, wherein the one or more sources of at least the first category comprise speech.

6. An apparatus as claimed in claim 1, wherein the remainder of the audio signals comprise ambient noise.

7. An apparatus as claimed in claim 1, wherein the instructions, when executed with the at least one processor, cause the apparatus to provide one or more masks that enables the portion corresponding to the one or more sources of at least the first category to be obtained.

8. An apparatus as claimed in claim 1, wherein the spatial information relating to one or more sources of at least the first category is estimated from a covariance matrix.

9. An apparatus as claimed in claim 1, wherein the spatial information relating to one or more sources of at least the first category comprises a steering vector.

10. An apparatus as claimed in claim 1, wherein the instructions, when executed with the at least one processor, cause the apparatus to at least one of:
obtain the portion corresponding to the one or more sources of at least the first category; or
direct a beamformer towards the one or more sources of at least the first category.

11. (canceled)

12. An apparatus as claimed in claim 10, wherein the instructions, when executed with the at least one processor, cause the apparatus to apply a filter to the beamformed signal to emphasize the portion based upon the one or more sources of at least the first category of the signal and suppress the remainder.

13. (canceled)

14. A method, comprising:
obtaining input data for a trained machine learning model wherein the input data is based on audio signals from two or more microphones configured for spatial audio capture;
determining, using the input data and the trained machine learning model, spatial information relating to one or more sources of at least a first category captured within the audio signals;
separating, at least partially, a portion of the audio signals corresponding to the one or more sources of at least the first category from a remainder of the audio signals; and
processing the portion corresponding to the one or more sources of at least the first category based on the spatial information determined using the trained machine learning model and processing at least the remainder of the audio signals based on information in the two or more audio signals.

15. A method as claimed in claim 14, wherein the processing of the one or more sources of at least the first category increases the relative volume of the one or more sources of at least the first category compared to the remainder.

16. A method as claimed in claim 14, wherein the trained machine learning model is used to separate, at least partially, the portion of the audio signals corresponding to the one or more sources of at least the first category from the remainder of the audio signals.

17. A non-transitory program storage device readable with an apparatus, tangibly embodying a program of instructions executable with the apparatus for performing operations, the operations comprising:
obtaining input data for a trained machine learning model wherein the input data is based on audio signals from two or more microphones configured for spatial audio capture;
determining, using the input data and the trained machine learning model, spatial information relating to one or more sources of at least a first category captured within the audio signals;
separating, at least partially, a portion of the audio signals corresponding to the one or more sources of at least the first category from a remainder of the audio signals; and
processing the portion corresponding to the one or more sources of at least the first category based on the spatial information determined using the trained machine learning model and processing at least the remainder of the audio signals based on information in the two or more audio signals.

18-20. (canceled)

21. A method as claimed in claim 14, wherein a different machine learning model is used to separate, at least partially, the portion of the audio signals corresponding to the one or more sources of at least the first category from the remainder of the audio signals.

22. A method as claimed in claim 14, wherein the one or more sources of at least the first category comprise speech.

23. A method as claimed in claim 14, wherein the remainder of the audio signals comprise ambient noise.

24. A method as claimed in claim 14, wherein the trained machine learning model is configured to provide one or more masks that enables the portion corresponding to the one or more sources of at least the first category to be obtained.

25. A method as claimed in claim 14, wherein the spatial information relating to one or more sources of at least the first category comprises at least one of:
an estimation from a covariance matrix; or
a steering vector.
